(19) United States
(12) Patent Application Publication
(10) Pub. No.: US 2025/0159750 A1
(43) Pub. Date: May 15, 2025

(54) COMMUNICATION APPARATUS, BASE STATION, AND COMMUNICATION METHOD

(71) Applicant: DENSO CORPORATION, Kariya-city (JP)

(72) Inventor: Tomoyuki YAMAMOTO, Kariya-city (JP)

(21) Appl. No.: 19/020,148

(22) Filed: Jan. 14, 2025

Related U.S. Application Data
(63) Continuation of application No. PCT/JP2023/026324, filed on Jul. 18, 2023.

(30) Foreign Application Priority Data
Jul. 20, 2022 (JP) 2022-115854

(51) Int. Cl. H04W 76/27; H04W 8/18

(52) U.S. Cl. CPC H04W 76/27; H04W 8/18

(57) ABSTRACT

A communication apparatus is a communication apparatus capable of communicating with a plurality of networks including a first network and a second network by using a plurality of subscriber identity modules. The communication apparatus comprises a controller, a transmitter configured to transmit, to a base station of the first network, a user equipment (UE) assistance information including first information and second information, the first information being used for indicating that a gap is preferred to be configured for the communication apparatus in a case where the communication apparatus performs communication using the plurality of subscriber identity modules, the second information being used for indicating a preference of the communication apparatus for configuring a gap, and a receiver configured to receive, from the base station of the first network, a radio resource control (RRC) reconfiguration message including third information used for configuring the gap. The controller is configured to control to transmit, to the base station of the first network, the UE assistance information including the first information and the second information in a case where the communication apparatus is configured to transmit the UE assistance information for each of the first information and the second information.

### CROSS-REFERENCE TO RELATED APPLICATION

The present application is a continuation application of international Patent Application No. PCT/JP2023/026324, filed on Jul. 18, 2023, which designated the U.S., and claims the benefit of priority of Japanese Patent Application No. 2022-115854, filed on Jul. 20, 2022, the entire contents of which are incorporated herein by reference.

### TECHNICAL FIELD

The present disclosure relates to a communication apparatus, a base station, and a communication method used in a mobile communication system.

### BACKGROUND ART

In 3rd Generation Partnership Project (3GPP, registered trademark. The same applies hereinafter), which is a standardization project of a mobile communication system, a communication apparatus (hereinafter, referred to as a multi-universal subscriber identity module (MUSIM) communication apparatus) that performs communication with a plurality of networks by using a plurality of subscriber identity modules has been specified. In the MUSIM communication apparatus, it is possible to configure a duration (hereinafter, referred to as a MUSIM gap) during which communication with a certain network (hereinafter, referred to as a first network) can be temporarily interrupted in order to perform a signaling reception operation (for example, monitoring of paging, obtaining of a system information block (SIB), or the like) from another network (hereinafter, referred to as a second network) while connection with the first network is maintained.

Currently, a work item for designing a feature of a MUSIM communication apparatus to communicate with a plurality of networks by using two transceivers has been launched (see Non Patent Literature 1).

### CITATION LIST

### Non Patent Literature

Non Patent Literature 1: 3GPP Contribution: “RP-220955”

### SUMMARY OF INVENTION

A communication apparatus according to a first aspect is a communication apparatus capable of communicating with a plurality of networks including a first network and a second network by using a plurality of subscriber identity modules. The communication apparatus comprises a controller, a transmitter configured to transmit, to a base station of the first network, a user equipment (UE) assistance information including first information and second information, the first information being used for indicating that a gap is preferred to be configured for the communication apparatus in a case where the communication apparatus performs communication using the plurality of subscriber identity modules, the second information being used for indicating a preference of the communication apparatus for configuring a gap, and a receiver configured to receive, from the base station of the first network, a radio resource control (RRC) reconfiguration message including third information used for configuring the gap. The controller is configured to control to transmit, to the base station of the first network, the UE assistance information including the first information and the second information in a case where the communication apparatus is configured to transmit the UE assistance information for each of the first information and the second information.

A base station according to a second aspect is a base station of a first network which communicates with a communication apparatus capable of communicating with a plurality of networks including the first network and a second network by using a plurality of subscriber identity modules. The base station comprises a controller, a receiver configured to receive, from the communication apparatus, a user equipment (UE) assistance information including first information and second information, the first information being used for indicating that a gap is preferred to be configured for the communication apparatus in a case where the communication apparatus performs communication using the plurality of subscriber identity modules, the second information being used for indicating a preference of the communication apparatus for configuring a gap, and a transmitter configured to transmit, to the communication apparatus, a radio resource control (RRC) reconfiguration message including third information used for configuring the gap. The controller is configured to control to receive, from the communication apparatus, the UE assistance information including the first information and the second information in a case where the communication apparatus is configured to transmit the UE assistance information for each of the first information and the second information.

A communication method according to a third aspect is a communication method executed in a communication apparatus capable of communicating with a plurality of networks including a first network and a second network by using a plurality of subscriber identity modules. The communication method comprises the steps of transmitting, to a base station of the first network, a user equipment (UE) assistance information including first information and second information, the first information being used for indicating that a gap is preferred to be configured for the communication apparatus in a case where the communication apparatus performs communication using the plurality of subscriber identity modules, the second information being used for indicating a preference of the communication apparatus for configuring a gap, receiving, from the base station of the first network, a radio resource control (RRC) reconfiguration message including third information used for configuring the gap, and controlling to transmit, to the base station of the first network, the UE assistance information including the first information and the second information in a case where the communication apparatus is configured to transmit the UE assistance information for each of the first information and the second information.

### BRIEF DESCRIPTION OF DRAWINGS

Objects, features, advantages, and the like of the present disclosure will become more apparent from the following detailed description with reference to the accompanying drawings.

FIG. 1 is a diagram illustrating a configuration example of a mobile communication system according to an embodiment.

FIG. 2 is a diagram illustrating a configuration example of a protocol stack of the mobile communication system according to the embodiment.

FIG. 3 is a diagram for describing an assumed scenario.

FIG. 4 is a diagram illustrating a configuration example of a UE according to the embodiment.

FIG. 5 is a diagram illustrating a configuration example of a base station of a first network according to the embodiment.

FIG. 6 is a sequence diagram for describing a first operation example according to the embodiment.

FIG. 7 is a diagram for describing an information element in the first operation example according to the embodiment.

### DESCRIPTION OF EMBODIMENTS

A mobile communication system according to an embodiment will be described with reference to the drawings. In the description of the drawings, the same or similar parts are denoted by the same or similar reference numerals.

In a case where a MUSIM communication apparatus performs communication with a plurality of cells in a first network, it is assumed that the MUSIM communication apparatus performs communication with some cells of the plurality of cells by using one transceiver and performs communication with remaining cells of the plurality of cells by using the other transceiver.

Here, the MUSIM communication apparatus in which a MUSIM gap is configured can continue communication with the first network even during the MUSIM in gap by interrupting communication with the remaining cells during the MUSIM gap and performing a signaling reception operation in a second network by using the other transceiver while continuing communication with some cells by using one transceiver. As a result, communication performance can be improved.

However, currently, it is unclear with which cell among the plurality of cells used for communication with the MUSIM communication apparatus the first network is to continue communication. Accordingly, communication between the first network and the MUSIM communication apparatus needs to be interrupted during the MUSIM gap, and there is still a concern that the communication performance cannot be improved.

Therefore, an object of the present disclosure is to provide a communication apparatus, a base station, and a communication method capable of continuing communication with a first network while performing a signaling reception operation in a second network during a MUSIM gap between the first network and the communication apparatus.

### Embodiment

### (System Configuration)

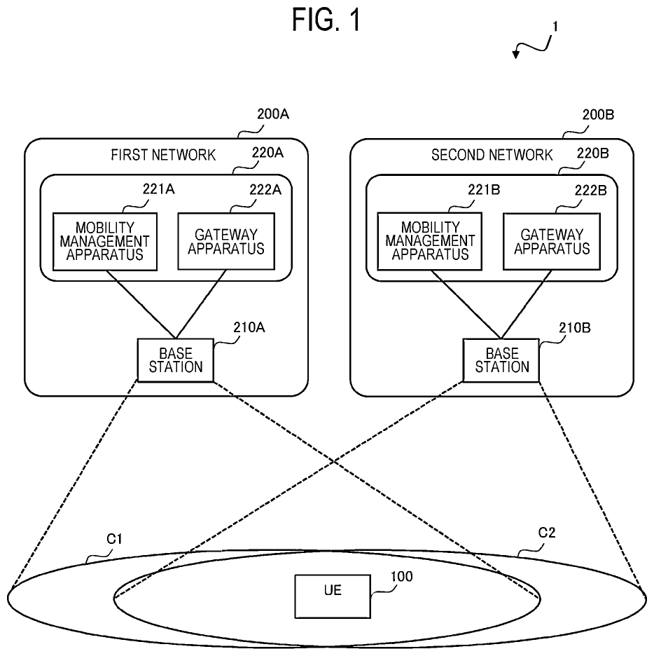

A configuration of a mobile communication system 1 according to an embodiment will be described with reference to FIG. 1. Hereinafter, an example in which the mobile communication system 1 is a fifth generation system (5G/NR: New Radio) in the 3GPP standard will be mainly described, but a fourth generation system (4G/LTE: Long Term Evolution) system and/or a sixth generation system may be at least partially applied to the mobile communication system 1.

As illustrated in FIG. 1, the mobile communication system 1 according to the embodiment includes a user equipment (UE) 100, a first network 200A, and a second network 200B.

The UE 100 is an example of a communication apparatus. The UE 100 may be a mobile radio communication apparatus. The UE 100 may be an apparatus used by a user. For example, the UE 100 is a mobile phone terminal (including a smartphone), a tablet terminal, a laptop PC, a communication module (including a communication card or a chipset), a sensor or equipment provided in the sensor, a vehicle or equipment provided in the vehicle (for example, a vehicle UE), or an aerial vehicle or equipment provided in the aerial vehicle (for example, an aerial UE). Note that the UE 100 may be referred to as another name such as a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, or a remote unit.

The UE 100 can communicate with a plurality of networks by using a plurality of subscriber identity modules (SIM). The UE 100 may be a multi-SIM device compatible with a plurality of SIMs. The UE 100 may be referred to as, for example, a MUSIM device. Hereinafter, an example in which the UE 100 is compatible with two SIMs will be mainly described; however, the UE 100 may be compatible with three or more SIMs. A case where “the UE is compatible with a plurality of SIMs” means that the UE 100 has an ability to handle a plurality of SIMs, and the UE 100 may not be necessarily equipped with the plurality of SIMs. Such a UE 100 may be referred to as a “UE supporting a plurality of SIMs”. Note that the SIM is not limited to a card type SIM (so-called a SIM card), and may be an embedded SIM (so-called an eSIM) that is integrated in the UE 100 in advance. The SIM may be referred to as a universal subscriber identity module (USIM).

The first network 200A is a network associated with one SIM of the UE 100. The second network 200B is a network associated with the other SIM of the UE 100. It is assumed that the UE 100 has performed location registration in the first network 200A by using one SIM and has performed location registration in the second network 200B by using the other SIM. That is, the UE 100 exists in each of the first network 200A and the second network 200B. The first network 200A and the second network 200B may be networks of different communication operators. However, the first network 200A and the second network 200B may be networks of the same communication operator. Different public land mobile network (PLMN) IDs may be allocated to the first network 200A and the second network 200B.

The first network 200A includes a base station 210A constituting a radio access network and a core network 220A. The core network 220A includes, as core network apparatuses, a mobility management apparatus 221A and a gateway apparatus 222A. Similarly, the second network 200B includes a base station 210B constituting a radio access network and a core network 220B. The core network 220B includes, as core network apparatuses, a mobility management apparatus 221B and a gateway apparatus 222B. Hereinafter, the base stations 210A and 210B will be simply referred to as a base station 210 in a case where these base stations are not distinguished, the mobility management apparatuses 221A and 221B will be simply referred to as a mobility management apparatus 221 in a case where the mobility management apparatuses are not distinguished, and the gateway apparatuses 222A and 222B will be simply referred to as a gateway apparatus 222 in a case where the gateway apparatuses are not distinguished.

The base station 210 is a radio communication apparatus that performs radio communication with the UE 100. The base station 210 manages one or a plurality of cells. The base station 210 performs radio communication with the UE 100 that has established connection with a cell in a radio resource control (RRC) layer. The base station 210 has a radio resource management (RRM) feature, a routing feature of user data (hereinafter, simply referred to as “data”), a measurement control feature for mobility control and scheduling, and the like. The “cell” is used as a term indicating a minimum unit of a radio communication area. The “cell” is also used as a term indicating a feature or a resource that performs radio communication with the UE 100. One cell belongs to one carrier frequency. FIG. 1 illustrates an example in which the base station 210A manages a cell C1 and the base station 210B manages a cell C2. The UE 100 is located in an overlapping region of the cell C1 and the cell C2.

The base station 210 may be a gNB, which is a base station in 5G/NR, or an eNB, which is a base station in 4G/LTE. Hereinafter, an example in which the base station 210 is the gNB will be mainly described. The feature of the base station 210 may be divided into a central unit (CU) and a distributed unit (DU). The base station 210 may be a relay node such as an Integrated access and backhaul (IAB) node.

The mobility management apparatus 221 is an apparatus supporting a control plane, and is an apparatus that performs various kinds of mobility management for the UE 100. The mobility management apparatus 221 communicates with the UE 100 by using non-access stratum (NAS) signaling and manages information on a tracking area in which the UE 100 exists. The mobility management apparatus 221 performs paging through the base station 210 to notify the UE 100 of an incoming call. The mobility management apparatus 221 may be an access and mobility management function (AMF) in 5G/NR or a mobility management entity (MME) in 4G/LTE.

The gateway apparatus 222 is an apparatus supporting a user plane and performs transfer control of data of the UE 100. The gateway apparatus 222 may be a user plane function (UPF) in 5G/NR or a serving gateway (S-GW) in 4G/LTE.

### (Configuration Example of Protocol Stack)

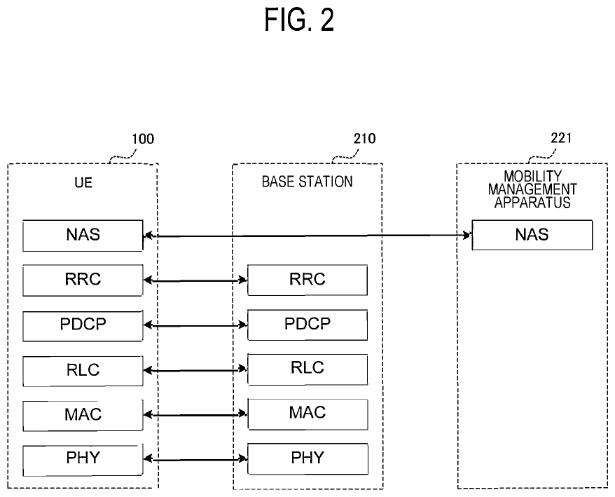

A configuration example of a protocol stack of the mobile communication system 1 will be described with reference to FIG. 2. As illustrated in FIG. 2, a protocol of a radio section between the UE 100 and the base station 210 includes a physical (PHY) layer, a medium access control (MAC) layer, a radio link control (RLC) layer, a packet data convergence protocol (PDCP) layer, and a radio resource control (RRC) layer.

The PHY layer performs encoding and decoding, modulation and demodulation, antenna mapping and demapping, and resource mapping and demapping. Data and control information are transmitted via a physical channel between the PHY layer of the UE 100 and the PHY layer of the base station 210.

The MAC layer performs data priority control, retransmission processing by hybrid ARQ (HARQ), a random access procedure, and the like. Data and control information are transmitted via a transport channel between the MAC layer of the UE 100 and the MAC layer of the base station 210. The MAC layer of the base station 210 includes a scheduler. The scheduler determines uplink and downlink transport formats (transport block size and modulation and coding scheme (MCS)) and resources to be allocated to the UE 100.

The RLC layer transmits data to the RLC layer on a reception side by using the features of the MAC layer and the PHY layer. Data and control information are transmitted via a logical channel between the RLC layer of the UE 100 and the RLC layer of the base station 210.

The PDCP layer performs header compression and decompression and encryption and decryption.

A service data adaptation protocol (SDAP) layer may be provided as an upper layer of the PDCP layer. The service data adaptation protocol (SDAP) layer performs mapping between an IP flow that is a unit in which a core network performs quality of service (QOS) control, and a radio bearer that is a unit in which an access stratum (AS) performs QoS control.

The RRC layer controls a logical channel, a transport channel, and a physical channel according to establishment, reestablishment, and release of the radio bearer. RRC signaling for various configurations is transmitted between the RRC layer of the UE 100 and the RRC layer of the base station 210. In a case where there is RRC connection between the RRC of the UE 100 and the RRC of the base station 210, the UE 100 is in an RRC connected state. In a case where there is no RRC connection between the RRC of the UE 100 and the RRC of the base station 210, the UE 100 is in an RRC idle state. In a case where the RRC connection between the RRC of the UE 100 and the RRC of the base station 210 is suspended, the UE 100 is in an RRC inactive state.

An NAS layer located above the RRC layer performs session management and mobility management of the UE 100. NAS signaling is transmitted between the NAS layer of the UE 100 and an NAS layer of the mobility management apparatus 221.

A mode (NAS state) in the NAS layer of the UE 100 includes an idle mode and a connected mode. In the connected mode, context information of the UE 100 is stored in the network, and in the idle mode, context information of the UE 100 is not stored in the network. In a case where the UE 100 is in the connected mode, the UE 100 is in the RRC connected state or the RRC inactive state. In a case where the UE 100 is in the idle mode, the UE 100 is in the RRC idle state.

The mode in the NAS layer may be a 5G mobility management (5GMM) mode. In this mode, the connected mode may be a 5GMM-connected mode, and the idle mode may be a 5GMM-idle mode.

Note that the UE 100 has an application layer and the like in addition to a radio interface protocol.

### (Assumed Scenario)

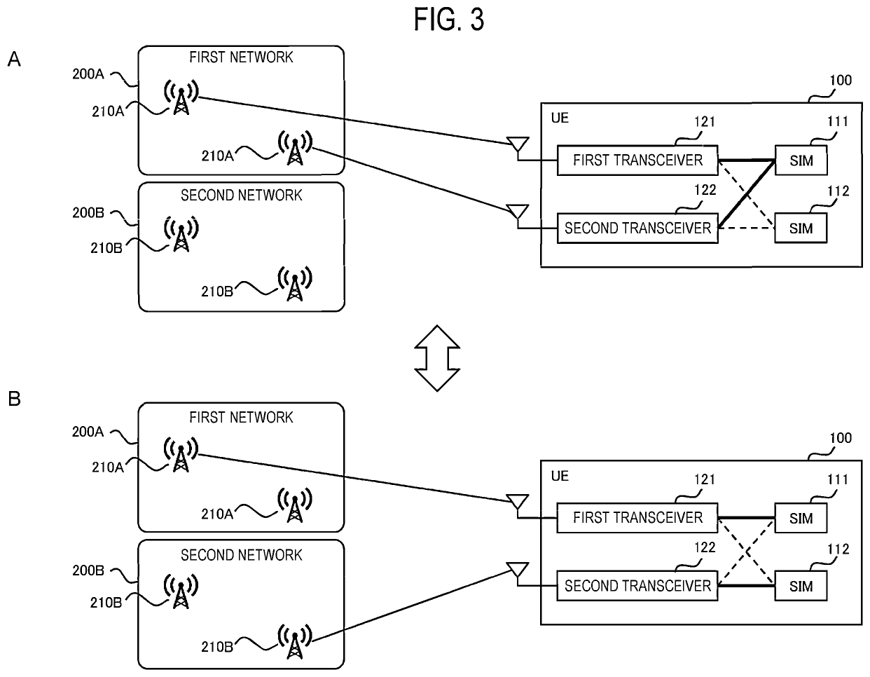

An assumed scenario in the mobile communication system 1 according to the embodiment will be described with reference to FIG. 3. In the 3GPP, which is the standardization project of the mobile communication system 1, the UE 100 that performs communication with a plurality of networks by using a plurality of subscriber identity modules is specified. In such a UE 100, it is possible to configure a duration (hereinafter, a MUSIM gap) during which communication with a certain network (for example, a first network 200A) can be temporarily interrupted in order to perform a signaling reception operation (for example, monitoring of paging, obtaining of a system information block (SIB), measuring, or the like) from another network (for example, a second network 200B) while connection with the first network 200A is maintained.

Currently, in Release 18 of the 3GPP, a work item for designing a feature of the UE 100 having two transceivers to perform communication with a plurality of networks by using a plurality of SIMs has been launched. For example, as illustrated in FIG. 3A, in a case where the UE 100 performs communication with the first network 200A by using a SIM 111, the UE 100 can use a first transceiver 121 and a second transceiver 122 for communication with the first network 200A. As illustrated in FIG. 3B, in a case where the UE 100 performs communication with the second network 200B by using a SIM 112, it is assumed that the second transceiver 122 is switched for communication with the second network 200B. As a result, the UE 100 can perform communication with the second network 200B by the second transceiver 122 while communication with the first network 200A is maintained by the first transceiver 121.

Here, in a case where the UE 100 performs communication with the plurality of cells in the first network 200A, it is assumed that the UE performs communication with the remaining cells of the plurality of cells by using the other transceiver (for example, the second transceiver 122) while performing communication with some cells of the plurality of cells by using one transceiver (for example, the first transceiver 121).

The UE 100 in which the MUSIM gap is configured can continue communication with the first network 200A even during the MUSIM gap by interrupting communication with the remaining cells during the MUSIM gap and performing the signaling reception operation in the second network 200B by using the second transceiver 122 while continuing communication with some cells by using the first transceiver 121. As a result, communication performance can be improved.

However, currently, it is unclear with which cell among the plurality of cells used for communication with the UE 100 the first network 200A is to continue communication. Accordingly, communication between the first network 200A and the UE 100 needs to be interrupted during the MUSIM gap, and there is still a concern that the communication performance cannot be improved. In an embodiment to be described later, the present disclosure describes an operation for enabling continuous communication with the first network while performing the signaling reception operation in the second network during the MUSIM gap between the first network and the communication apparatus.

### (Configuration Example of UE)

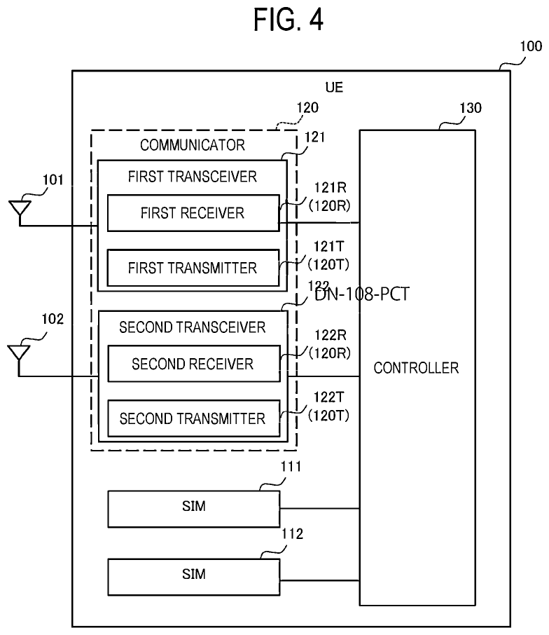

A configuration example of the UE 100 will be described with reference to FIG. 4. As illustrated in FIG. 4, the UE 100 includes an antenna 101, an antenna 102, the SIM 111, the SIM 112, a communicator 120, and a controller 130. The antenna 101 and the antenna 102 may be provided outside the UE 100. The SIM 111 and the SIM 112 are SIM cards or eSIMs.

The SIM 111 stores subscriber information and configuration information necessary for the UE 100 to communicate with the first network 200A. The SIM 111 stores identification information of the UE 100 in the first network 200A, for example, a telephone number, an international mobile subscriber identity (IMSI), and the like. The SIM 111 corresponds to a first subscriber information module. The UE 100 communicates with the first network 200A by using the SIM 111.

The SIM 112 stores subscriber information and configuration information necessary for the UE 100 to communicate with the second network 200B. The SIM 112 stores identification information of the UE 100 in the second network 200B, for example, a telephone number, an IMSI, and the like. The SIM 112 corresponds to a second subscriber information module. The UE 100 communicates with the second network 200B by using the SIM 112.

The communicator 120 performs radio communication with the first network 200A and radio communication with the second network 200B via the antenna 101 under the antenna 102 under the controller 130. The communicator 120 includes a plurality of transceivers. The transceiver may be referred to as a transceiver or a radio frequency (RF) chain. In the present embodiment, the communicator 120 includes the first transceiver 121 and the second transceiver 122. The first transceiver 121 and the second transceiver 122 include a receiver 120R and a transmitter 120T. The receiver 120R converts a radio signal received by each antenna into a received signal that is a baseband signal, performs signal processing on the received signal, and outputs the processed signal to the controller 130. The transmitter 120T performs signal processing on a transmitted signal that is a baseband signal output from the controller 130, converts the processed transmitted signal into a radio signal, and transmits a radio signal from each antenna. The receiver 120R may be referred to as a receiver, an Rx chain, or an Rx branch. The transmitter 120T may be referred to as a transmitter, a Tx chain, or a Tx branch. In the present embodiment, the first transceiver 121 includes a first receiver 121R as the receiver 120R, and includes a first transmitter 121T as the transmitter 120T. The second transceiver 122 includes a second receiver 122R as the receiver 120R and a second transmitter 122T as the transmitter 120T.

The controller 130 controls the communicator 120 and performs various kinds of control in the UE 100. The controller 130 controls communication with the first network 200A by using the SIM 111 and controls communication with the second network 200B by using the SIM 112. The controller 130 includes at least one processor and at least one memory. The memory stores a program executed by the processor and information used for processing by the processor. The memory may include at least one of a read only memory (ROM), an erasable programmable read only memory (EPROM), an electrically erasable programmable read only memory (EEPROM), a random access memory (RAM), and a flash memory. The processor may include a digital signal processor (DSP) that performs digital processing on a digital signal and a central processing unit (CPU) that executes a program. Note that a part of the memory may be provided in the communicator 120. In addition, the DSP may be provided in the communicator 120.

In the UE 100 having the above configuration, the controller 130 controls communication with each of a plurality of cells belonging to the first network 200A. A transmitter 120T transmits, to the first network 200A, identification information for identifying a target cell in which communication is interrupted, among the plurality of cells, during the MUSIM gap. A receiver 120R receives configuration information for configuring the MUSIM gap from the first network 200A. As a result, the first network 200A (specifically, a base station 210A) can grasp a target cell in which the UE 100 interrupts the communication. As a result, the first network 200A can grasp that communication with cells other than the target cell can be continued, and can grasp which cell among the plurality of cells used for communication with the UE 100 communication is to be continued. Communication between the UE 100 and the first network 200A is performed in the target cell, and thus, communication can be continued even during the MUSIM gap. As a result, the communication performance can be improved.

Note that an operation of a functional unit (specifically, at least one of an antenna 101, an antenna 102, a SIM 111, a SIM 112, a communicator 120, and a controller 130) included in the UE 100 may be described as an operation of the UE 100.

### (Configuration Example of Base Station)

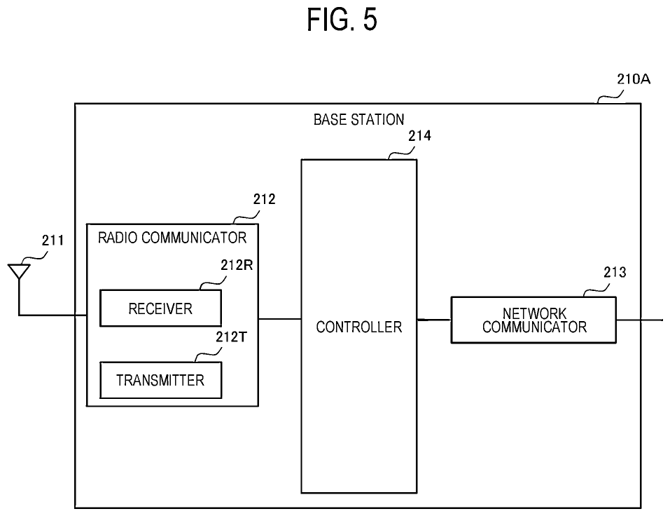

A configuration example of the base station 210A of the first network 200A will be described with reference to FIG. 5. Note that since the base station 210B of the second network 200B also has the same configuration as the base station 210A, the description thereof will be omitted. As illustrated in FIG. 5, the base station 210A includes an antenna 211, a radio communicator 212, a network communicator 213, and a controller 214.

The radio communicator 212 performs communication with the UE 100 via the antenna 211 under the control of the controller 214. The radio communicator 212 includes a receiver 212R and a transmitter 212T. The receiver 212R converts a radio signal received by the antenna 211 into a received signal that is a baseband signal, performs signal processing on the received signal, and outputs the processed signal to the controller 214. The transmitter 212T performs signal processing on a transmitted signal that is a baseband signal output from the controller 214, converts the processed transmitted signal into a radio signal, and transmits the radio signal from the antenna 211.

The network communicator 213 is connected to the core network 220A. The network communicator 213 performs network communication with the mobility management apparatus 221A and the gateway apparatus 222A under the control of the controller 214.

The controller 214 controls the radio communicator 212 and performs various kinds of control in the base station 210A. The controller 214 includes at least one processor and at least one memory. The memory stores a program executed by the processor and information used for processing by the processor. The memory may include at least one of a ROM, an EPROM, an EEPROM, a RAM, and a flash memory. The processor may include a digital signal processor (DSP) that performs digital processing on a digital signal and a central processing unit (CPU) that executes a program. Note that a part of the memory may be provided in the radio communicator 212. In addition, the DSP may be provided in the radio communicator 212.

In a base station 210 having the above configuration, a receiver 212R receives, from the UE 100, the identification information for identifying the target cell in which communication is interrupted, among the plurality of cells, during the MUSIM gap. A transmitter 212T transmits the configuration information for configuring the MUSIM gap to the UE 100. As a result, the first network 200A (specifically, a base station 210A) can grasp a target cell in which the UE 100 interrupts the communication. As a result, the first network 200A can grasp that communication with cells other than the target cell can be continued, and can grasp which cell among the plurality of cells used for communication with the UE 100 communication is to be continued. Communication between the UE 100 and the first network 200A is performed in the target cell, and thus, communication can be continued even during the MUSIM gap. As a result, the communication performance can be improved.

Note that an operation of a functional unit (specifically, at least one of the antenna 211, the radio communicator 212, the network communicator 213, and the controller 214) included in the base station 210A may be described as an operation of the base station 210A.

### (Operation of Mobile Communication System)

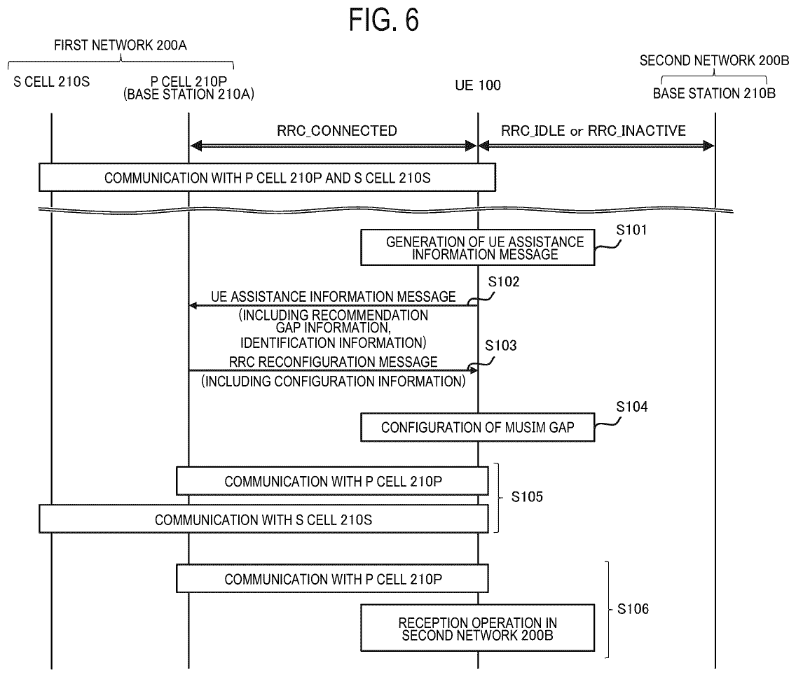

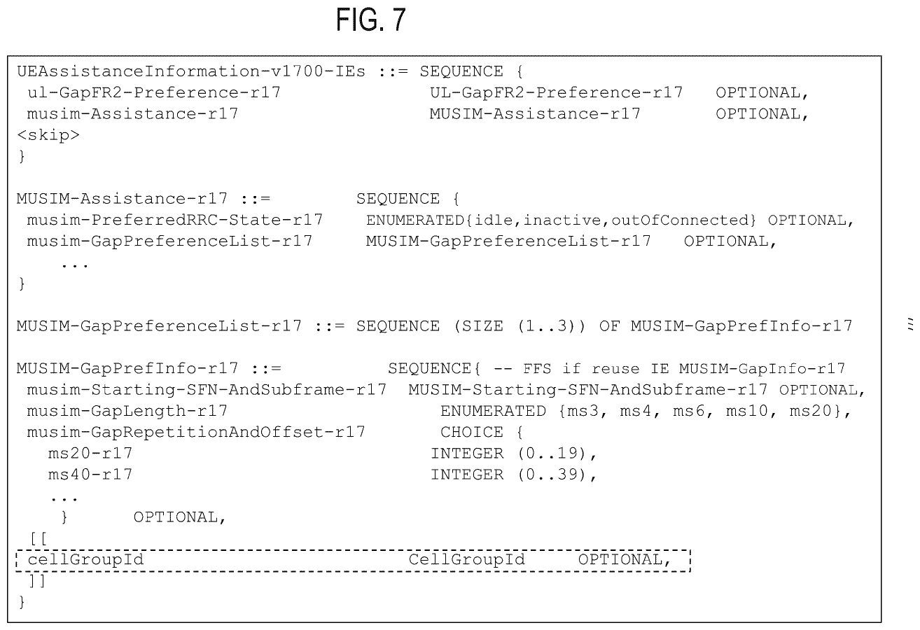

A first operation example of the mobile communication system 1 will be described with reference to FIGS. 6 and 7. In the present operation example, the UE 100 exists in a primary cell (P cell) 210P and a secondary cell (S cell) 210S of the first network 200A. One base station 210A of the first network 200A may manage the P cell 210P and the S cell 210S. Alternatively, a certain base station 210A of the first network 200A may manage the P cell 210P, and another base station 210A of the first network 200A may manage the S cell 210S. Note that the P cell 210P may be a P cell in a carrier aggregation operation. In addition, the S cell 210S may be an S cell in the carrier aggregation operation. In addition, the P cell 210P may be a P cell belonging to a master cell group (MCG) in a dual connectivity operation. In addition, the S cell 210S may be a primary secondary cell (PS cell) belonging to a secondary cell group (SCG) in the dual connectivity operation. In addition, the S cell 210S may be a secondary cell (S cell) belonging to the master cell group (MCG) and/or the secondary cell group (SCG) in the dual connectivity operation.

Here, the P cell of the master cell group (MCG) and/or the primary secondary cell (PS cell) belonging to the secondary cell group (SCG) in the dual connectivity operation are also referred to as special cells (SP cells). In addition, in the dual connectivity operation, an MAC entity may be associated with each of the master cell group (MCG) and the secondary cell group (SCG).

Hereinafter, for ease of description, in the present embodiment, the P cell belonging to the master cell group (MCG) is also referred to as a P cell. In addition, the primary secondary cell (PS cell) belonging to the secondary cell group (SCG) is also referred to as a secondary cell. That is, in the present embodiment, the P cell may be replaced with the P cell belonging to the master cell group (MCG). In addition, in the present embodiment, the secondary cell may be replaced with the primary secondary cell (PS cell) and/or the secondary cell (S cell) belonging to the secondary cell group (SCG).

As illustrated in FIG. 6, the UE 100 is in the RRC connected state in the first network 200A. In the UE 100 in the RRC connected state, the RRC connection is established between the first network 200A and the UE 100. Accordingly, the controller 130 of the UE 100 and the controller 214 of the base station 210 perform control to establish the RRC connection between the UE 100 and the base station 210. In addition, the UE 100 may be in an RRC idle state or an RRC inactive state in the second network 200B.

In addition, the UE 100 performs communication with the first network 200A. The UE 100 is in communication with the first network 200A. For example, a service such as a voice call is provided to the UE 100 from the first network 200A. In the present embodiment, the UE 100 controls communication with each of the plurality of cells belonging to the first network 200A. The UE 100 performs communication with the P cell 210P and the S cell 210S as the plurality of cells. The controller 130 of the UE 100 controls communication with the P cell 210P and the S cell 210S. Note that “in communication” means that the UE 100 is at least in the RRC connected state in the network. Accordingly, in a case where the UE is in communication with the first network 200A, the UE 100 consecutively performs continuous or discontinuous exchange of data with the network.

Hereinafter, communication between the UE 100 and the base station 210A may be communication between the UE 100 and a cell (specifically, the P cell 210P or the S cell 210S) of the base station 210A, that is, the cell in which the UE 100 exists for the UE 100. The same applies to communication between the UE 100 and the base station 210B. In addition, communication between the UE 100 and a node (for example, the base station 210A (that is, the P cell 210P or the S cell 210S), the mobility management apparatus 221A, or the gateway apparatus 222A) belonging to the first network 200A may be referred to as communication between the UE 100 and the first network 200A. The same applies to the UE 100 and a node belonging to the second network 200B.

In addition, hereinafter, the UE 100 performs communication (specifically, transmission and reception/notification of messages, and the like) with the first network 200A via the communicator 120 (specifically, the receiver 120R and/or the transmitter 120T), but for the sake of convenience in description, the description of the communication via the communicator 120 will be appropriately omitted. Similarly, the description that communication between the UE 100 and the second network 200B is also the communication via the communicator 120 will be appropriately omitted. Accordingly, the transmission and/or reception of the messages and the like of the UE 100 may be transmission and/or reception of messages and the like of the communicator 120 (specifically, the receiver 120R and/or the transmitter 120T) of the UE 100.

### Step S101:

As illustrated in FIG. 6, the controller 130 of the UE 100 generates a UE assistance information message used for indication of a UE assistance information for the first network 200A. For example, in a case where a MUSIM assistance information is provided, the controller 130 may generate the UE assistance information message. Here, the MUSIM assistance information may include a preference of the UE 100 for MUSIM. That is, the controller 130 may generate the UE assistance information message including the preference of the UE 100 regarding the following information. For example, in the RRC connected state in the first network 200A, the controller 130 may generate the UE assistance information message including the following information as the preference of the UE 100 for MUSIM.

The controller 130 includes, in the UE assistance information message, the identification information for identifying the target cell in which communication is interrupted, among the plurality of cells, during the gap (hereinafter, referred to as the MUSIM gap) for communicating with the second network 200B. Note that the MUSIM gap may be a duration during which the signaling reception operation is performed in the second network 200B. For example, the controller 130 may include, in the UE assistance information message, identification information for identifying a cell in which the gap for MUSIM is configured. Here, the cell in which the gap for MUSIM is configured may include a primary cell, a primary secondary cell, and/or a secondary cell. That is, the target cell may include a primary cell, a primary secondary cell, and/or a secondary cell.

For example, the controller 130 may determine the target cell based on a situation such as a communication load of each cell that performs communication in the first network 200A. In addition, the controller 130 may determine the target cell based on, for example, a frequency band used in the second network 200B.

As described above, for example, the controller 130 may determine the secondary cell as the target cell, or may determine, as the target cell, at least one cell (for example, a primary secondary cell and/or a secondary cell) belonging to the secondary cell group. For example, the controller 130 may determine, as the target cell, a cell within a frequency range overlapping at least a part of the frequency band used in the second network 200B. The controller 130 may determine a cell in a frequency range 2 (FR2) as the target cell.

The identification information may be, for example, a cell group identifier (for example, CellGroupId) for identifying a cell group including the target cell. For example, the controller 130 may include a cell group identifier indicating a secondary cell group to which the S cell 210S belongs in the UE assistance information message. In addition, the identification information may be, for example, a physical cell identifier of the target cell. For example, the controller 130 may include a physical cell identifier indicating the S cell 210S in the UE assistance information message.

The identification information may be an identifier of a frequency of the target cell. The identification information may be, for example, an absolute radio-frequency channel number (ARFCN) of the target cell. In addition, the identification information may indicate, for example, a frequency range (for example, FR1, FR2, or the like) including the target cell.

In addition, the controller 130 may include gap recommendation information indicating a MUSIM gap recommended to be configured by the UE 100 in the UE assistance information message. That is, the controller 130 may include information indicating a configuration of a MUSIM gap preferred by the UE 100 in the UE assistance information message.

The gap recommendation information may be, for example, musim-GapPreferenceList, MUSIM-GapPrefInfo, or the like. The gap recommendation information may include, for example, at least one of information (for example, musim-GapLength) indicating ae length of a MUSIM gap length recommended by the UE 100, information (for example, musim-GapOffset) indicating a gap offset of a MUSIM gap recommended by the UE 100, information (for example, musim-PrefStarting-SFN-AndSubframex) indicating a gap initiation location of an aperiodic MUSIM gap recommended by the UE 100 while the RRC connected state is maintained, and information (for example, musim-GapRepetitionAndOffsetPeriod) indicating a gap reception duration and a gap offset of a periodic MUSIM gap recommended by the UE 100 while the RRC connected state is maintained.

The controller 130 may include the identification information in the gap recommendation information. For example, as illustrated in FIG. 7, the controller 130 may include identification information (for example, cellGroupId) in MUSIM-GapPrefInfo. In addition, the controller 130 may individually include the gap recommendation information and the identification information in a multi-universal subscriber identity module (MUSIM) assistance information element (that is, MUSIM-Assistance) used to provide the MUSIM assistance information.

### Step S102:

The transmitter 120T of the UE 100 transmits the UE assistance information message to the first network 200A (specifically, the base station 210A). As a result, the transmitter 120T transmits the identification information and the gap recommendation information to the first network 200A. That is, the UE 100 may transmit, to the first network 200A, the UE assistance information message including the information indicating the configuration of the gap for MUSIM and the identification information for identifying the cell in which the gap for MUSIM is configured. The radio communicator 212 of the base station 210A receives the UE assistance information message from the UE 100 in the P cell 210P. Here, the information indicating the configuration of the gap for MUSIM may include information indicating setup and/or release of the gap for MUSIM.

The controller 214 of the base station 210A can grasp a target cell recommended by the UE 100 based on the identification information included in the UE assistance information message. In addition, the controller 214 can grasp a gap recommended by the UE 100 based on the gap recommendation information.

The controller 214 may generate MUSIM gap configuration information based on at least one of the gap recommendation information and the identification information. In addition, the controller 214 generates an RRC reconfiguration message including the generated MUSIM gap configuration information.

The MUSIM gap configuration information may indicate, for example, a MUSIM gap configuration and may control the setup/release of the gap for MUSIM. The MUSIM gap configuration information may be, for example, musim-GapConfig or MUSIM-GapConfig. Note that the MUSIM gap configuration information may include at least one of information (for example, musim-GapToAddModList) indicating a list for adding or changing a periodic MUSIM gap pattern identifier without being changed from the RRC connected state, information (for example, musim-GapToReleaseList) indicating a list for releasing the periodic MUSIM gap pattern identifier without being changed from the RRC connected state, and information (for example, musim-AperiodicGap) indicating that the UE 100 is permitted to use the aperiodic MUSIM gap in a case where the request is performed by the UE 100 in the UE assistance information message. In addition, the MUSIM gap configuration information may include at least one of information (musim-Start-SFN-AndSubframe) indicating a gap initiation location for a periodic MUSIM gap that is not changed from the RRC connected state, information (musim-GapLength) indicating a length of a MUSIM gap length, information (musim-GapRepetitionAndOffset) indicating a gap offset of the number of subframes for the periodic MUSIM gap that is not changed from the RRC connected state and a gap repetition duration in milliseconds, and a MUSIM gap identifier (for example, MUSIM-GapID) for identifying the periodic MUSIM gap for adding, changing, or releasing.

For example, the controller 214 may include the identification information for identifying the target cell in the MUSIM gap configuration information. The target cell identified by the identification information may be the same as or different from the target cell received from the UE 100. In a case where a target of the MUSIM gap configured based on the MUSIM gap configuration information is different from the target cell indicated by the identification information received from the UE 100, the controller 214 may include the identification information, or may include the identification information regardless of whether or not the target cell is different from the target cell indicated by the identification information received from the UE 100.

The controller 214 may include the identification information in the MUSIM gap configuration information in parallel with musim-GapToAddModList, musim-GapToReleaseList, and musim-AperiodicGap. The controller 214 may include the identification information in the MUSIM gap configuration information in parallel with information (musim-GapLength) indicating the length of the MUSIM gap length or the like.

### Step S103:

The transmitter 212T of the base station 210A transmits the RRC reconfiguration message to the UE 100 in the P cell 210P. As a result, the transmitter 212T transmits, to the UE 100, the configuration information (hereinafter, referred to as MUSIM gap configuration information) for configuring the MUSIM gap. The receiver 120R of the UE 100 receives the RRC reconfiguration message from the base station 210A (P cell 210P). As a result, the receiver 120R receives the MUSIM gap configuration information.

### Step S104:

The controller 130 of the UE 100 configures the MUSIM gap. The controller 130 configures the MUSIM gap based on the MUSIM gap configuration information.

In a case where the identification information is received from the first network 200A, for example, in a case where the identification information is included in the MUSIM gap configuration information, the controller 130 may configure the MUSIM gap for the target cell indicated by the identification information. In a case where the identification information is not received from the first network 200A, for example, in a case where the identification information is not included in the MUSIM gap configuration information, the controller 130 may configure the MUSIM gap for the target cell indicated by the identification information included in the UE assistance information message.

The controller 130 executes the following operation based on the MUSIM gap configuration information. Specifically, the controller 130 executes processing of step S105 in a duration other than the MUSIM gap. On the other hand, the controller 130 executes processing of step S106 in the duration other than the MUSIM gap.

### Step S105:

The controller 130 of the UE 100 controls communication with the P cell 210P and communication with the S cell 210S in the duration other than the configured MUSIM gap. For example, the controller 130 controls communication with the P cell 210P using the first transceiver 121. The controller 130 controls communication with the S cell 210S using the second transceiver 122.

### Step S106:

The controller 130 of the UE 100 performs control to interrupt communication with the S cell 210S during the configured MUSIM gap. The controller 130 may perform control to switch the second transceiver 122 used for communication with the S cell 210S to a reception operation for receiving signaling in the second network 200B.

The controller 130 controls communication with the P cell 210P and the reception operation in the second network 200B in the configured MUSIM gap. For example, the controller 130 controls communication with the P cell 210P using the first transceiver 121. The controller 130 controls the reception operation for receiving signaling in the second network 200B using the second transceiver 122.

After the reception operation is ended, the controller 130 may perform control to switch the second transceiver 122 used for the reception operation for receiving signaling in the second network 200B for communication with the S cell 210S.

As described above, the controller 130 controls communication with each of the plurality of cells belonging to the first network 200A. A transmitter 120T transmits, to the first network 200A, identification information for identifying a target cell in which communication is interrupted, among the plurality of cells, during the MUSIM gap. The receiver 120R receives the MUSIM gap configuration information for configuring the MUSIM gap from the first network 200A. In addition, the receiver 212R of the base station 210A receives the identification information from the UE 100. The transmitter 212T of the base station 210A transmits the MUSIM gap configuration information to the UE 100. As a result, the first network 200A (specifically, a base station 210A) can grasp a target cell in which the UE 100 interrupts the communication. As a result, the first network 200A can grasp that communication with cells other than the target cell can be continued, and can grasp which cell among the plurality of cells used for communication with the UE 100 communication is to be continued. As a result, the UE 100 and the first network 200A can continue communication even during the MUSIM gap.

In addition, the transmitter 120T may transmit, to the first network 200A, a message including the identification information and the gap recommendation information. As a result, the first network 200A can grasp the MUSIM gap recommended to be configured by the UE 100 based on the gap recommendation information. The first network 200A can grasp that communication with the target cell indicated by the identification information is desired during the MUSIM gap based on the gap recommendation information. The first network 200A can generate the MUSIM gap configuration information in consideration of the identification information and the gap recommendation information.

In addition, the transmitter 120T may receive the identification information for identifying the target cell from the first network 200A. As a result, the UE 100 can grasp the target cell designated by the first network 200A. The UE 100 can control the target cell in which the first network 200A interrupts communication by configuring the gap in the target cell indicated by the identification information received from the first network 200A.

In addition, the identification information may be a cell group identifier for identifying a cell group including the target cell. As a result, the amount of information included in the message can be reduced as compared with a case where the target cell is identified by the identifier of each cell.

In addition, the identification information may be a physical cell identifier of the target cell. As a result, the target cell can be flexibly configured.

In addition, the controller 130 may configure the gap in the target cell indicated by the identification information received from the first network 200A. The UE 100 can control the target cell in which the first network 200A interrupts communication by configuring the gap in the target cell indicated by the identification information received from the first network 200A.

### Other Embodiments

In the above-described embodiment, the first network 200A may transmit, to the UE 100, the RRC reconfiguration message including information for configuring the transmission of the UE assistance information message including the preference of the UE 100 regarding the information indicated above (see, specifically, steps S101 and S102). For example, the first network 200A may configure the UE 100 to transmit the UE assistance information message for each piece of the information indicated above. In addition, the first network 200A may transmit, to the UE 100, an RRC reconfiguration message including a timer (a value of the timer) initiated based on the transmission of the UE assistance information message including the preference of the UE 100 regarding the information described above. That is, the first network 200A may configure, in the UE 100, a timer for the transmission of the preference of the UE 100 regarding the information described above. Here, the timer (the value of the timer) may also be referred to as a prohibit timer (a value of the prohibit timer). For example, the first network 200A may configure, in the UE 100, a timer for each piece of the information described above.

In addition, in a case where the transmission of the UE assistance information message including the preference of the UE 100 regarding the information indicated above is configured, the UE 100 may transmit the UE assistance information message. That is, in a case where the transmission of the UE assistance information message including the preference of the UE 100 is configured by the first network 200A, the UE 100 having a capability to provide the preference regarding the information indicated above may transmit the UE assistance information message to the first network 200A. In addition, the UE 100 may initiate the timer based on the transmission of the UE assistance information message including the preference of the UE 100. Here, in a case where the timer is not operating, the UE 100 may transmit, to the first network 200A, the UE assistance information message including the preference of the UE 100. In addition, in a case where the preference of the UE 100 regarding the information described above is released (including a case where the release of the preference of the UE 100 regarding the information described above is instructed by the first network 200A), the UE 100 may stop the timer. For example, the UE 100 may stop the timer based on the release of the preference of the UE 100 regarding the information indicated above in a connection reestablishment procedure. Here, the connection reestablishment procedure may include a connection reestablishment procedure with the first network 200A. In addition, the UE 100 may stop the timer based on initiating of a connection resumption procedure. Here, the connection resumption procedure may include the connection resumption procedure with the first network 200A. In addition, the UE 100 may also stop the timer based on the fact that the release of the information for configuring the transmission of the UE assistance information message including the preference of the UE 100 regarding the information indicated above is instructed by the first network 200A. In addition, in a case where a current preference of the UE 100 is different from a preference of the UE 100 indicated by last transmission of the UE assistance information message including the preference of the UE 100, the UE 100 may transmit the UE assistance information message to the first network 200A. That is, in a case where the transmission of the UE assistance information message including the preference of the UE 100 regarding the information indicated above is configured, the timer is not operating, and the current preference of the UE 100 is different from the preference of the UE 100 transmitted last time, the UE 100 may transmit the UE assistance information message to the first network 200A.

In the above-described embodiment, although it has been described that the UE assistance information message is used as the message including the identification information for identifying the target cell by the controller 130 of the UE 100, the present disclosure is not limited thereto. The controller 130 may include the identification information in another message.

For example, in a case where the target cell is changed, the controller 130 of the UE 100 may transmit the identification information to the first network 200A. In addition, for example, in a case where the configuration of the MUSIM gap in the dedicated cell is ended, the controller 130 may transmit a UE assistance information message not including the identification information to the first network 200A.

The operation sequence (and the operation flow) in the above-described embodiment may not necessarily be executed in time series according to the order described in the flow diagram or the sequence diagram. For example, the steps in the operation may be executed in an order different from the order described in the flowchart or the sequence diagram, or may be performed in parallel. In addition, some of the steps in the operation may be removed or additional steps may be added to the processing. In addition, the operation sequence (and the operation flow) in the above-described embodiment may be performed separately and independently, or may be performed by combining two or more operation sequences (and operation flows). For example, some steps of one operation flow may be added to other operation flows, or some steps of one operation flow may be replaced with some steps of other operation flows.

In the above-described embodiments, the mobile communication system based on the NR is described as the example of the mobile communication system 1. However, the mobile communication system 1 is not limited to this example. The mobile communication system 1 may be a system conforming to a TS of long term evolution (LTE) or another generation system (for example, a sixth generation) of the 3GPP standard. The base station 210 may be an eNB configured to provide protocol terminations of E-UTRA user plane and control plane toward the UE 100 in LTE. The mobile communication system 1 may be a system conforming to a TS defined in a standard other than the 3GPP standard. The base station 210 may be an integrated access and backhaul (IAB) donor or an IAB node.

A program may be provided for causing a computer to execute each processing to be performed by the UE 100 or the base station 210. The program may be recorded on a computer readable medium. By using the computer readable medium, the program can be installed in the computer. Here, the computer readable medium in which the program is recorded may be a non-transitory recording medium. The non-transitory recording medium is not particularly limited to, but may be, for example, a recording medium such as a compact disk read only memory (CD-ROM) or a digital versatile disc read only memory (DVD-ROM). In addition, a circuit that executes each processing to be performed by the UE 100 or the base station 210 may be integrated, and at least a part of the UE 100 or the base station 210 may be configured as a semiconductor integrated circuit (chipset, SoC (system-on-chip)).

In the above-described embodiment, the term “transmit” may mean performing processing of at least one layer in a protocol stack used for transmission, or may mean physically transmitting a signal in a wireless or wired manner. Alternatively, the term “transmit” may mean a combination of performing processing of at least one layer in a protocol stack used for transmission and physically transmitting a signal in a wireless or wired manner. Similarly, the term “receive” may mean performing processing of at least one layer in a protocol stack used for reception, or may mean physically receiving a signal in a wireless or wired manner. Alternatively, the term “receive” may mean a combination of performing processing of at least one layer in a protocol stack used for reception and physically receiving a signal in a wireless or wired manner. Similarly, the term “obtain/acquire” may mean obtaining/acquiring information from stored information, may mean obtaining/acquiring information from information received from another node, or may mean obtaining/acquiring information by generating the information. Similarly, the term “based on” and “depending on/in response to” do not mean “only based on” or “only on depending/only in response to” unless explicitly stated otherwise. The term “based on” means both “only based on” and “at least partially based on”. Similarly, the term “depending on/in response to” means both “only depending on/in response to” and “at least partially depending on/in response to”. Similarly, the terms “include” and “comprise” do not mean including only enumerated items, but mean both including only enumerated items and including additional items in addition to the enumerated items. Similarly, in the present disclosure, the “or” does not mean exclusive OR but means OR. Moreover, any reference to elements using designations such as “first”, “second”, and the like used in the present disclosure does not generally limit the amount or order of those elements. These designations may be used in the present disclosure as a convenient method to distinguish between two or more elements. References to first and second elements do not mean that only two elements can be employed therein or that the first element should precede the second element in any form. In the present disclosure, when articles such as a, an, and the in English are added by translation, these articles cover the plural meaning unless the context clearly indicates otherwise.

Although the present disclosure has been described in accordance with examples, it is understood that the present disclosure is not limited to the examples or structures. The present disclosure also covers various modified examples or modifications made within an equivalent range. In addition, various combinations or modes, or other combinations or modes including only one element, more elements, or less elements also fall within the scope and spirit of the present disclosure.

### (Supplementary Notes)

Features related to the above-described embodiments are additionally described.

### [Supplementary Note 1]

A communication apparatus (100) capable of communicating with a plurality of networks (200A and 200B) by using a plurality of subscriber identity modules, the communication apparatus comprising:
a controller (130) configured to control communication with each of a plurality of cells belonging to a first network (200A);
a transmitter (120T) configured to transmit, to the first network, identification information for identifying a target cell in which the communication is interrupted, among the plurality of cells, during a gap for communicating with a second network (200B); and
a receiver (120R) configured to receive configuration information for configuring the gap from the first network.

### [Supplementary Note 2]

The communication apparatus according to supplementary note 1, wherein the transmitter is configured to transmit, to the first network, a message including the identification information and gap recommendation information indicating the gap recommended to be configured by the communication apparatus.

### [Supplementary Note 3]

The communication apparatus according to supplementary note 1 or 2, wherein the receiver is configured to receive identification information for identifying the target cell from the first network.

### [Supplementary Note 4]

The communication apparatus according to supplementary note 3, wherein the identification information is a cell group identifier for identifying a cell group including the target cell.

### [Supplementary Note 5]

The communication apparatus according to supplementary note 3 or 4, wherein the identification information is a physical cell identifier of the target cell.

### [Supplementary Note 6]

The communication apparatus according to any one of supplementary notes 3 to 5, wherein the controller configures the gap in the target cell indicated by the identification information received from the first network.

### [Supplementary Note 7]

A base station (210A) of a first network in a mobile communication system including a communication apparatus capable of communicating with a plurality of networks by using a plurality of subscriber identity modules, the base station comprising:
a receiver (212R) configured to receive, from the communication apparatus that controls communication with each of a plurality of cells belonging to the first network, identification information for identifying a target cell in which the communication is interrupted, among the plurality of cells, during a gap for communicating with a second network; and
a transmitter (212T) configured to transmit configuration information for configuring the gap to the communication apparatus.

### [Supplementary Note 8]

A communication method executed in a communication apparatus capable of communicating with a plurality of networks by using a plurality of subscriber identity modules, the communication method comprising the steps of:
controlling communication with each of a plurality of cells belonging to a first network;
transmitting, to the first network, identification information for identifying a target cell in which the communication is interrupted, among the plurality of cells, during a gap for communicating with the second network; and receiving configuration information for configuring the gap from the first network.

1. A communication apparatus capable of communicating with a plurality of networks including a first network and a second network by using a plurality of subscriber identity modules, the communication apparatus comprising:
a controller;
a transmitter configured to transmit, to a base station of the first network, a user equipment (UE) assistance information including first information and second information, the first information being used for indicating that a gap is preferred to be configured for the communication apparatus in a case where the communication apparatus performs communication using the plurality of subscriber identity modules, the second information being used for indicating a preference of the communication apparatus for configuring a gap; and
a receiver configured to receive, from the base station of the first network, a radio resource control (RRC) reconfiguration message including third information used for configuring the gap, wherein
the controller is configured to control to transmit, to the base station of the first network, the UE assistance information including the first information and the second information in a case where the communication apparatus is configured to transmit the UE assistance information for each of the first information and the second information.

2. The communication apparatus according to claim 1, wherein
the receiver is configured to receive, from the base station of the first network, a RRC reconfiguration message including information used for configuring the communication apparatus to transmit the UE assistance information for each of the first information and the second information.

3. The communication apparatus according to claim 1, wherein
the second information includes at least one of information for indicating a preference of the communication apparatus for configuring a periodic gap and information for indicating a preference of the communication apparatus for configuring an aperiodic gap.

4. A base station of a first network which communicates with a communication apparatus capable of communicating with a plurality of networks including the first network and a second network by using a plurality of subscriber identity modules, the base station comprising:
a controller;
a receiver configured to receive, from the communication apparatus, a user equipment (UE) assistance information including first information and second information, the first information being used for indicating that a gap is preferred to be configured for the communication apparatus in a case where the communication apparatus performs communication using the plurality of subscriber identity modules, the second information being used for indicating a preference of the communication apparatus for configuring a gap; and
a transmitter configured to transmit, to the communication apparatus, a radio resource control (RRC) reconfiguration message including third information used for configuring the gap, wherein
the controller is configured to control to receive, from the communication apparatus, the UE assistance information including the first information and the second information in a case where the communication apparatus is configured to transmit the UE assistance information for each of the first information and the second information.

5. The base station according to claim 4, wherein
the transmitter is configured to transmit, to the communication apparatus, a RRC reconfiguration message including information used for configuring the communication apparatus to transmit the UE assistance information for each of the first information and the second information.

6. The base station according to claim 4, wherein
the second information includes at least one of information for indicating a preference of the communication apparatus for configuring a periodic gap and information for indicating a preference of the communication apparatus for configuring an aperiodic gap.

7. A communication method executed in a communication apparatus capable of communicating with a plurality of networks including a first network and a second network by using a plurality of subscriber identity modules, the communication method comprising the steps of:
transmitting, to a base station of the first network, a user equipment (UE) assistance information including first information and second information, the first information being used for indicating that a gap is preferred to be configured for the communication apparatus in a case where the communication apparatus performs communication using the plurality of subscriber identity modules, the second information being used for indicating a preference of the communication apparatus for configuring a gap;
receiving, from the base station of the first network, a radio resource control (RRC) reconfiguration message including third information used for configuring the gap; and
controlling to transmit, to the base station of the first network, the UE assistance information including the first information and the second information in a case where the communication apparatus is configured to transmit the UE assistance information for each of the first information and the second information.

8. The communication method according to claim 7, further comprising the step of:
receiving, from the base station of the first network, a RRC reconfiguration message including information used for configuring the communication apparatus to transmit the UE assistance information for each of the first information and the second information.

9. The communication method according to claim 8, wherein
the second information includes at least one of information for indicating a preference of the communication apparatus for configuring a periodic gap and information for indicating a preference of the communication apparatus for configuring an aperiodic gap.
